(19) United States
(12) Patent Application Publication
(10) Pub. No.: US 2025/0109336 A1
(43) Pub. Date: Apr. 3, 2025

(54) WATER-SOLUBLE FOAMING AGENT FOR MAKING BUBBLE SOLUTION AND METHOD FOR PREPARING SAME

(71) Applicant: Taizhou Sunup Tech. Co., Ltd., Taizhou (CN)

(72) Inventor: Xianli CHEN, Taizhou (CN)

(73) Assignee: Taizhou Sunup Tech. Co., Ltd., Taizhou (CN)

(21) Appl. No.: 18/477,336

(22) Filed: Sep. 28, 2023

(51) Int. Cl. C09K 23/00; C09K 23/02; C09K 23/38; C09K 23/48

(52) U.S. Cl. CPC C09K 23/017; C09K 23/002; C09K 23/02; C09K 23/38; C09K 23/48

(57) ABSTRACT

Disclosed are a water-soluble foaming agent for making a bubble solution and a method for preparing the same. The water-soluble foaming agent for making a bubble solution includes a solid foaming agent and a water-soluble coating wrapped around the solid foaming agent in a weight ratio of 10:1 to 20:1. The solid foaming agent includes the following raw materials in percentage by weight: 25 to 45% of surfactant, 4 to 8% of stabilizer, 4 to 12% of glycerol, 10 to 25% of starch, 2 to 6% of pH-sensitive adhesive and 4 to 20% of sugar. The water-soluble coating includes the following raw materials in percentage by weight: 65 to 85% of film former, 2 to 15% of plasticizer and the balance of one or more of colorant or auxiliary additive.

### TECHNICAL FIELD

The present disclosure belongs to the technical field of bubble solutions, and particularly relates to a water-soluble foaming agent for making a bubble solution and a method for preparing the same.

### BACKGROUND

Bubble solutions are used in a wide range from children's toys to the decoration of large stages, making our life funny and colorful. The bubble solution can form a number of consecutive bubbles by reducing the surface tension of water under the action of external airflow.

Common formulae for homemade bubble solutions are: tea, detergent and white sugar; soap, tea and granulated sugar; detergent, water and white sugar; and glue, water and detergent. However, bubbles produced by these homemade bubble solutions are not rich enough and are easy to burst, so these homemade bubble solutions have a poor bubbling effect. Moreover, bubble solutions sold on the market are all in the form of a concentrate, which is inconvenient to use and leaks out easily. Moreover, the bubble solution in the liquid form is high in storage and transportation costs.

### SUMMARY

An objective of the present disclosure is to provide a water-soluble foaming agent for making a bubble solution and a method for preparing the same. The water-soluble foaming agent is formed by wrapping a water-soluble coating around a solid structure prepared from bubble solution ingredients. As long as the water-soluble foaming agent is put into water, the water-soluble coating is dissolved such that the solid foaming agent is mixed with the water to form the bubble solution. The water-soluble foaming agent is convenient to store, transport and use, and low in costs.

The present disclosure is implemented as follows.

A water-soluble foaming agent for making a bubble solution includes a solid foaming agent and a water-soluble coating wrapped around the solid foaming agent in a weight ratio of 10:1 to 20:1.

The solid foaming agent includes the following raw materials in percentage by weight: 25 to 45% of surfactant, 4 to 8% of stabilizer, 4 to 12% of glycerol, 10 to 25% of starch, 2 to 6% of pH-sensitive adhesive and 4 to 20% of sugar.

The water-soluble coating includes the following raw materials in percentage by weight: 65 to 85% of film former, 2 to 15% of plasticizer and the balance of one or more of colorant or auxiliary additive.

In the water-soluble foaming agent for making a bubble solution, the surfactant is at least one of sodium lauryl sulfate, sodium dodecylbenzenesulfonate, alkenyl sulfonate, ammonium dodecyl sulfate, sodium lauroyl sarcosinate, alkyl glycoside and peregal.

In the water-soluble foaming agent for making a bubble solution, the stabilizer is at least one of methyl cellulose, hydroxyethyl cellulose, hydroxypropyl methylcellulose, sodium gluconate, polyvinyl alcohol (PVA) and sodium polyacrylate.

In the water-soluble foaming agent for making a bubble solution, the film former is at least one of hydroxypropyl methylcellulose, hydroxypropyl cellulose, PVA or copovidone.

In the water-soluble foaming agent for making a bubble solution, the plasticizer is at least one of ethylene glycol, propylene glycol, castor oil, acetylated monoglyceride or phthalate.

In the water-soluble foaming agent for making a bubble solution, the colorant is at least one of ferric oxide, edible pigment and titanium dioxide.

In the water-soluble foaming agent for making a bubble solution, the auxiliary additive is at least one of talcum powder, magnesium stearate, glycerol monostearate or silicon dioxide.

Another objective of the present disclosure is to provide a method for preparing the water-soluble foaming agent for making a bubble solution, including the following steps:
step 1: drying a surfactant, a stabilizer, glycerol, starch, a pH-sensitive adhesive and sugar;
step 2: proportionally stirring and grinding the surfactant, the stabilizer, the glycerol, the starch, the pH-sensitive adhesive and the sugar that have been dried in step 1 until they are uniformly mixed to obtain mixed powder;
step 3: granulating or tabletting the mixed powder in step 2 to form solid foaming agent granules;
step 4: proportionally adding a film former, a plasticizer, and a colorant or/and an auxiliary additive into water, and stirring the mixture to form a coating solution; and
step 5: drying the coating solution obtained in step 4 such that a film is formed and shaped so as to form a water-soluble coating bag with an inner cavity, putting the solid foaming agent granules obtained in step 3 into the inner cavity of the water-soluble coating bag, and sealing the water-soluble coating bag to finally obtain the water-soluble foaming agent.

Compared with the prior art, the present disclosure has the following outstanding advantages.

The water-soluble foaming agent of the present disclosure is formed by wrapping the water-soluble coating around a solid structure prepared from bubble solution ingredients. As long as the water-soluble foaming agent is put into water, the water-soluble coating is dissolved such that the solid foaming agent is mixed with the water to form the bubble solution. The formed bubble solution has a good bubbling effect, and bubbles are not easy to burst. Moreover, the solid water-soluble foaming agent is convenient to store, transport and use, and low in costs.

### DETAILED DESCRIPTION OF THE EMBODIMENTS

The present disclosure will be further described in conjunction with specific examples.

### Example I

A water-soluble foaming agent for making a bubble solution includes a solid foaming agent and a water-soluble coating wrapped around the solid foaming agent in a weight ratio of 20:1.

The solid foaming agent includes the following raw materials in percentage by weight: 38% of surfactant, 7% of stabilizer, 10% of glycerol, 25% of starch, 5% of pH-sensitive adhesive and 15% of sugar.

The water-soluble coating includes the following raw materials in percentage by weight: 75% of film former, 12% of plasticizer, 3% of colorant and 10% of auxiliary additive.

In this example, the surfactant in the solid foaming agent is sodium lauryl sulfate. In addition, the stabilizer for stabilizing and assisting foaming can increase a viscosity of the bubble solution and improve a toughness of bubbles. The stabilizer is hydroxyethyl cellulose.

Moreover, the film former of the water-soluble coating is hydroxypropyl methylcellulose and hydroxypropyl cellulose. The plasticizer is ethylene glycol. The colorant is ferric oxide. The auxiliary additive is magnesium stearate.

### Example II

A water-soluble foaming agent for making a bubble solution includes a solid foaming agent and a water-soluble coating wrapped around the solid foaming agent in a weight ratio of 20:1.

The solid foaming agent includes the following raw materials in percentage by weight: 35% of surfactant, 6% of stabilizer, 10% of glycerol, 25% of starch, 6% of pH-sensitive adhesive and 18% of sugar.

The water-soluble coating includes the following raw materials in percentage by weight: 85% of film former, 10% of plasticizer and 5% of auxiliary additive.

In this example, the surfactant in the solid foaming agent is peregal. In addition, the stabilizer for stabilizing and assisting foaming can increase a viscosity of the bubble solution and improve a toughness of bubbles. The stabilizer is sodium polyacrylate.

Moreover, the film former of the water-soluble coating is polyvinyl alcohol (PVA). The plasticizer is acetylated monoglyceride. The auxiliary additive is silicon dioxide.

In addition, a method for preparing the water-soluble foaming agent for making a bubble solution includes the following steps:

Step 1: A surfactant, a stabilizer, glycerol, starch, a pH-sensitive adhesive and sugar are dried until a water content is less than or equal to 5%.

Step 2: The surfactant, the stabilizer, the glycerol, the starch, the pH-sensitive adhesive and the sugar that have been dried in step 1 are proportionally stirred and ground until they are uniformly mixed to obtain mixed powder.

Step 3: The mixed powder in step 2 is granulated or tabletted to form solid foaming agent granules.

Step 4: A film former, a plasticizer, and a colorant or/and an auxiliary additive are proportionally added into water, and the mixture is stirred to form a coating solution.

Step 5: The coating solution obtained in step 4 is dried such that a film is formed and shaped so as to form a water-soluble coating bag with an inner cavity, the solid foaming agent granules obtained in step 3 is put into the inner cavity of the water-soluble coating bag, and the water-soluble coating bag is sealed to finally obtain the water-soluble foaming agent.

The above example is only one of the preferred examples of the present disclosure, and it is not intended to limit the scope of implementation of the present disclosure. Therefore, all equivalent changes made according to the shape, structure and principle of the present disclosure shall fall into the scope of protection of the present disclosure.

What is claimed is:

1. A water-soluble foaming agent for making a bubble solution, comprising a solid foaming agent and a water-soluble coating wrapped around the solid foaming agent in a weight ratio of 10:1 to 20:1; wherein
the solid foaming agent comprises the following raw materials in percentage by weight: 25 to 45% of surfactant, 4 to 8% of stabilizer, 4 to 12% of glycerol, 10 to 25% of starch, 2 to 6% of pH-sensitive adhesive and 4 to 20% of sugar; and
the water-soluble coating comprises the following raw materials in percentage by weight: 65 to 85% of film former, 2 to 15% of plasticizer and the balance of one or more of colorant or auxiliary additive.

2. The water-soluble foaming agent for making a bubble solution according to claim 1, wherein the surfactant is at least one of sodium lauryl sulfate, sodium dodecylbenzenesulfonate, alkenyl sulfonate, ammonium dodecyl sulfate, sodium lauroyl sarcosinate, alkyl glycoside and peregal.

3. The water-soluble foaming agent for making a bubble solution according to claim 1, wherein the stabilizer is at least one of methyl cellulose, hydroxyethyl cellulose, hydroxypropyl methylcellulose, sodium gluconate, polyvinyl alcohol (PVA) and sodium polyacrylate.

4. The water-soluble foaming agent for making a bubble solution according to claim 1, wherein the film former is at least one of hydroxypropyl methylcellulose, hydroxypropyl cellulose, PVA or copovidone.

5. The water-soluble foaming agent for making a bubble solution according to claim 1, wherein the plasticizer is at least one of ethylene glycol, propylene glycol, castor oil, acetylated monoglyceride or phthalate.

6. The water-soluble foaming agent for making a bubble solution according to claim 1, wherein the colorant is at least one of ferric oxide, edible pigment and titanium dioxide.

7. The water-soluble foaming agent for making a bubble solution according to claim 1, wherein the auxiliary additive is at least one of talcum powder, magnesium stearate, glycerol monostearate or silicon dioxide.

8. A method for preparing the water-soluble foaming agent for making a bubble solution according to claim 1, comprising the following steps:
step 1: drying a surfactant, a stabilizer, glycerol, starch, a pH-sensitive adhesive and sugar;
step 2: proportionally stirring and grinding the surfactant, the stabilizer, the glycerol, the starch, the pH-sensitive adhesive and the sugar that have been dried in step 1 until they are uniformly mixed to obtain mixed powder;
step 3: granulating or tabletting the mixed powder in step 2 to form solid foaming agent granules;
step 4: proportionally adding a film former, a plasticizer, and a colorant or/and an auxiliary additive into water, and stirring the mixture to form a coating solution; and
step 5: drying the coating solution obtained in step 4 such that a film is formed and shaped so as to form a water-soluble coating bag with an inner cavity, putting the solid foaming agent granules obtained in step 3 into the inner cavity of the water-soluble coating bag, and sealing the water-soluble coating bag to finally obtain the water-soluble foaming agent.
